(19) United States
(12) Patent Application Publication
(10) Pub. No.: US 2026/0211767 A1
(43) Pub. Date: Jul. 23, 2026

(54) KUBERNETES OBSERVABILITY ROOT-CAUSE ANALYZER WITH COMPLIANCE INTEGRATION

(71) Applicant: HEWLETT PACKARD ENTERPRISE DEVELOPMENT LP, Spring, TX (US)

(72) Inventors: Lalit Mahimraj Somavarapha, San Jose, CA (US); Prasad Adireddi, Bangalore (IN)

(21) Appl. No.: 19/169,536

(22) Filed: Apr. 3, 2025

(30) Foreign Application Priority Data
Jan. 17, 2025 (IN) 202541004023

(51) Int. Cl. G06F 11/07

(52) U.S. Cl. CPC G06F 11/0793; G06F 11/0709; G06F 11/079

(57) ABSTRACT

Systems and methods are provided for comprehensive observability into a cluster of nodes of a container management system for proactive compliance driven root-cause detection within the cluster. Examples train a root-cause analyzer for a cluster of a container management system by applying historical cluster observability data to a set of machine learning (ML) models. Examples detect technological anomalous events in the container management system and identify compliance events at compute nodes of the cluster based on cluster observability data received from the cluster. Examples predict a root-cause of the one or more technological anomalous events based on the compliance events and prioritize remedial actions to rectify the root-cause based on the compliance events and the technological anomalous.

### CROSS REFERENCE TO RELATED APPLICATIONS

This application is related to co-pending and co-owned India Patent Application No. 202541004024 filed on even date herewith, titled “KUBERNETES OBSERVABILITY ROOT-CAUSE REMEDIAL ACTIONS WITH COMPLIANCE INTEGRATION”, attorney docket number P175570.1IN, the contents of which are incorporated herein by reference in their entirety.

### BACKGROUND

Kubernetes is an open-source container management system for automating software deployment, scaling, and management. Kubernetes assembles one or more nodes into a cluster, which can be orchestrated to run workloads in containers. Kubernetes can work with various container runtimes, such as container and CRI-O. Its suitability for running and managing workloads of all sizes and styles has led to its widespread adoption in clouds and data centers.

Kubernetes defines a set of building blocks, called primitives, which collectively provide mechanisms for deploying, maintaining, and scaling applications based on CPU, memory, or other metrics. Kubernetes can be loosely coupled and extensible to meet needs of different workloads. The internal components as well as extensions and containers that run on Kubernetes rely on the Kubernetes application-programming interface (API). Kubernetes controls compute and storage resources by defining resources as objects, which can then be managed accordingly. The components of Kubernetes can be divided into those that manage an individual node and those that a cluster of individual nodes.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a schematic diagram of an example cluster of a container management system, in accordance with examples of the present disclosure.

FIG. 2 depicts a schematic block diagram of an example computer system for root-cause analysis, in accordance with examples disclosed herein.

FIG. 3 is schematic diagram illustrating a container management system 300, according to an example consistent with the present disclosure.

FIG. 4 is a computing component that may be used to implement examples of a predictive root-cause analyzer of the disclosed technology.

FIG. 5 is another computing component that may be used for root-cause analysis of a Kubernetes environment in accordance with the disclosed technology.

FIG. 6 depicts a block diagram of an example computer system in which various examples of the disclosed technology described herein may be implemented.

The figures are not exhaustive and do not limit the present disclosure to the precise form disclosed.

### DETAILED DESCRIPTION

Examples of the technology disclosed herein provide an artificial intelligence (AI) driven system for comprehensive observability into a cluster of nodes of a container management system (such as, but not limited to, Kubernetes) for proactive compliance driven root-cause detection within the cluster. The examples disclosed herein may be utilized to recognize anomalous events within the cluster, identify a root-cause of the events, and facilitate resolving the root-cause. The disclosed technology leverages AI to learn to recognize technological anomalous events and identify a root-cause by applying a plurality of machine learning (ML) models to historical cluster observability data of past events. The examples herein integrate governance and security compliance checks with the root-cause analysis to ensure data privacy and security compliance, as well as leveraging violations to identify a root-cause of a technological anomalous event. The disclosed technology may take remedial actions to avoid such situations that lead can result in future anomalous events.

As used herein, the term “technological anomalous event,” may be used herein to refer to an event of, relating to, or concerning with a technology or technical environment that deviates from or is inconsistent with the usual, normal, or expected operation. An anomalous event may be an occurrence of an irregularity in the operation of a cluster of nodes (e.g., a Kubernetes environment), which may be a manifestation of a root-cause issue. A number of such events detected at locations within the cluster may represent an anomalous pattern that can be detected as a technological issue. Examples herein may be then be utilized to identify and locate a root-cause of the technological issue (e.g., a source of the issue), which may occurring a different location, either physical or virtual, within the cluster relative to the detected technological anomalous events. That is the technological issue may be a manifestation or effect of the underlying root-cause.

Current container management systems face several technical challenges. For example, the interconnected nature of components makes root-cause analysis difficult. Various components work together in an interconnected network to run workloads, such that anomalous events may occur at any point along the workload pipeline. While the anomalous events (e.g., the problem) may arise at one point along the pipeline, these events may be manifestation of an underlying issue, which may not be easily traced back to the source. Additionally, as clusters grow, traditional monitoring methods may become inefficient and most current solutions identify issues after they cause problems. That is, current systems may be unable to recognizing events as being manifestations of an underlying issue until after the cluster experiences a larger problem, such as nodes going offline or being unable to perform assigned tasks.

As another example of a technical challenge experienced by conventional container management system is that they may require manual handholding by DevOps. If anything goes wrong, even the simplest of problems, an administrator (or some other team member of the DevOps team) may need to take over manually to remedy the issue. However, given the interconnected nature of components, DevOps teams may struggle to correlate and analyze the vast amounts of data from multiple sources within the cluster.

While there are some conventional solutions for monitoring container management systems, these tools suffer from limited learning and lack comprehensive insights for resource allocation and system performance, which negatively influences performance optimization. For example, current tools may not be configure to learn from past issues, which can lead to reoccurrence. Also, current are rudimentary and single dimensional, thereby restricting a comprehensive approach for resource allocation and system performance. These current tools may therefore fail to provide full observability in the cluster. Some examples of traditional monitoring tools include Prometheus and Grafan, but both of these focus on metrics, lacking advanced analytics and requiring manual correlation. ELK stack (Elasticsearch, Logstach, Kibana) is an example of a log management system, but is limited to log analysis and lacks contextualize from other data sources. Application performance monitoring (APM) tools are often application-centric (e.g., focused on a single application), and therefore may miss infrastructure-level issues. By focusing on a single dimensional aspect of the environment, these approaches may be unable to gain a full, comprehensive understanding of the cluster and technological anomalous events occurring therein.

Further, conventional solutions are agnostic to security and governance compliance requirements, which can lead to a failure to identify root-causes that may not manifest as a technological issue until it is too late to correct. For example, an operation may access an API or user endpoint that exposes personally identifiable information (PII). The operation itself may be expected as technologically expected, but it may cause downstream issues. Furthermore, the severity of a technologically anomalous event may be greater where security and/or privacy compliance is an issue. For example, an anomalous pattern of errors alone may not be of high importance, but if these errors are occurring at a sensitive endpoint/API the severity of such occurrence may be of greater import. Conventional solutions may not consider the security and governance compliance requirements and thus may further lack a comprehensive approach to root-cause analysis.

Examples of the technology disclosed herein provide a technical solution to the above-described shortcomings of conventional container management system monitoring tools. Examples disclosed herein collect cluster observability data of different types from various tools implemented in a cluster of nodes, such as a Kubernetes environment. For example, the technology disclosed herein may obtain metric data (e.g., from Prometheus, Grafan, or similar tools), log entry data (e.g., from ELK stack or similar tools) and trace data (e.g., from Jaeger tools or the like) via application programming interfaces (APIs).

The disclosed examples may be configured to build predictive root-cause analyzer that detects technological anomalous events and recognizing anomalous patterns, which the predicative root-cause analyzer can use to identify and locate a root-cause. The predictive root-cause analyzer may be built by training an ensemble of ML from historical data of the collected data types. In some examples, the predictive root-cause analyzer may include a clustering algorithms for grouping similar events, natural language processing (NLP) for analyzing log entry data, Bayesian Networks for training and modeling relationships between components of the cluster to construct a structural topography of the cluster, deep learning models (e.g., Long Short-Term Memory (LSTM) or similar models) for time-series anomaly prediction, and reinforcement learning for adaptive troubling shooting. For example, the predictive root-cause analyzer may execute NLP to analyze log entry data, which represent events. The clustering algorithm may cluster similar events, which can be correlated with metric data and trace data using Bayesian Networks to train relationships between events, metrics and components. The deep learning models can be leveraged to predict future events based on the clustering and correlated data. The disclosed system can recommend remedial actions, for example, through reinforcement learning based on administrators (or other DevOp team member) actions as training inputs.

Examples disclosed herein can also leverage governance compliance and security checks to ensure data privacy compliance, access control/authentication, and API security, to name of few. In some examples, the governance and security compliance (referred to herein collective as compliance) may be set forth as a plurality of rules, stored to a database. Examples herein may be configured to analyze events and verify the events comply with compliance criteria as set forth in the rules. For example, the predictive root-cause analyzer may comprise an ML model trained on the compliance criteria that may correlate technological anomalous events with security compliance violation events (e.g., data privacy violations, access control/authentication, API security, Audit trail requirements, secure communications, and the like) in a cluster of nodes. By correlating the technological anomalous events with the security compliance violation events, the disclosed technology can incorporate real-time compliance evaluation into the core root-cause analysis. This allows the disclosed technology to identify and prioritize issues that have both technological and compliance implications, providing a more comprehensive view of system health and risk.

In examples, the ensemble of ML models trained to provide the predictive root-cause analyzer includes a first one or more ML models trained to detect technological anomalous events in the cluster of nodes and a second one or more ML models trained to identify compliance events at one or more of the compute nodes (also referred to herein as worker nodes, for example, in the context of a Kubernetes environment). From the technological anomalous events, an anomalous pattern can be identified (e.g., a manifestation of a root-cause issue) and correlated with compliance events. From this correlation, a root-cause of the technological anomalous events can be detected and located within the cluster of compute nodes. That is, for example, the compliance violation at one location in the cluster may be causing technological anomalous events elsewhere, and, by correlating the two, the predictive root-cause analyzer may be able to locate the root-cause of the technological anomalous events. In examples, a third one or more ML models can be trained to assign a risk score to the root-cause, which can be used to rank the detected root-cause against other root-causes for prioritizing remedial actions in rectifying the root-cause.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

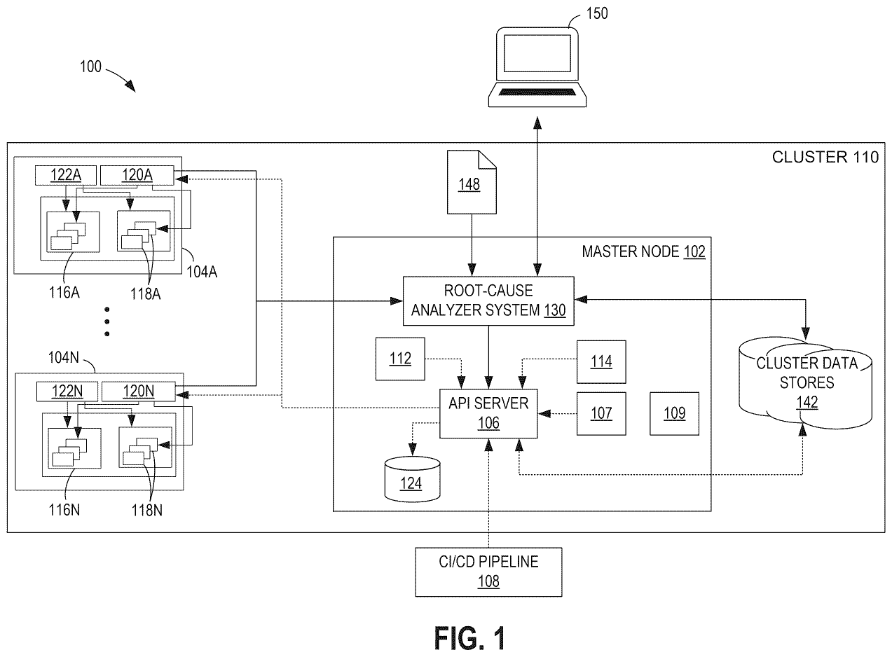

FIG. 1 is a schematic diagram of an example cluster 110 of a container management system 100, in accordance with examples of the present disclosure. As illustrated in the example of FIG. 1, container management system 100 according may include cluster 110, such as a Kubernetes environment in various examples. The cluster 110 may include a master node 102, which is responsible for managing the cluster 110, and multiple worker nodes 104A-104N (hereinafter referred to collectively as worker nodes 104) within which services of the cluster 110 operate to perform an operation requested over an interface with a CI/CD pipeline 108. Examples of such requested operations can include, but are not limited to, operations such as create deployment, delete deployment, update deployment, and so forth. While two worker nodes 104 are illustrated in FIG. 1 for brevity sake, it will be understood that the cluster 110 may include more than two worker nodes 104 (e.g., such as N number of worker nodes 104).

The master node 102 can be the entry point of administrative tasks for the cluster 110 and may be responsible for orchestrating one or more worker nodes 104, within which the services of the cluster 110 for generating an operation can be located. The master node 102, in this example, includes an API server 106 that provides both the internal and external interface access to the container management system 100 via the master node 102. The API server 106 may be configured to receive commands, known as representational state transfer (REST) commands, from the CI/CD pipeline 108, such as a kubectl command line interface for example. The REST commands may provide a set of architectural constraints that, when applied as a whole, emphasize scalability of component interactions, generality of interfaces, independent deployment of components, and intermediary components. The API server 106 processes the REST command requests, validates the commands, and executes the logic within the commands.

The results of the REST commands processed by the API server 106 may be stored in a storage component 124, such as an etcd storage component for example, included within the master node 102. The etcd storage component reliably stores configuration data of the cluster, representing the state of the cluster (i.e., what nodes exist in the cluster, what pods should be running, which nodes should they be running on, etc.). The storage component 124 may be a distributed, key value storage used for shared configuration and service directory. The storage component 124 provides storage for REST commands received by the API server 106 to perform create-update-and-delete (CRUD) operations as well as an interface to register watchers on specific nodes, thereby providing a reliable way to notify the rest of the cluster 110 about configuration changes within the cluster 110. For example, the shared information in the storage component 124 can enable the API server 106 to notify the entire cluster 110 about configuration changes such as jobs being scheduled, created and deployed, pod/service details and state, name spaces and replication information, and so forth.

The master node 102 may include a scheduler 112 and a controller manager 114. The scheduler 112 can be included in the master node 102 to deploy pods and services onto the worker nodes 104. The scheduler 112 may include information regarding available resources on the cluster 110, as well as resources utilized for the services to run. As a result, the scheduler 112 may make decisions on where to deploy a specific service. The controller manager 114 uses the API server 106 to watch the shared state of the cluster 110. For example, the controller manager 114 can make corrective changes to the current state of the cluster 110 to change the current state to another state, re-create a failed pod or remove an extra-scheduled pod. In addition, the master node 102 can include a DNS server 107, such as a for example, which schedules the DNS pod and services on the cluster, and configures the kubelets to instruct individual containers to use the DNS service's IP to resolve DNS names 109.

A number of pods 116A-116N (hereinafter referred to collectively as pods 116) may be co-located in each of the worker nodes 104, and one or more containers 118A-118N (hereinafter referred to collectively as containers 118) may reside within each of the pods 116. The containers 118 may be co-located on the host machine (e.g., a machine where containers are running, such as, the worker node), and can share resources. The pods 116, which are the basic scheduling unit in Kubernetes, add a higher level of abstraction by grouping containerized components that share resources, such as storage, Linux namespaces, cgroups, IP addresses, and so forth. Each of the pods 116 can be assigned a unique IP address within the cluster 110, which allows applications to use ports without the risk of conflict. Each of the pods 116 can define a volume, such as a local disk directory or a network disk, and expose the volume to the containers 118 within the pods 116. The pods 116 may be managed through the API server 106, or the management of the pods 116 may be delegated to a controller.

The containers 118 may hold the running operation along with the libraries and components or services to run the software needed to execute an operation. These components may include files, environment variables, dependencies, and libraries. The host operating system (operating system running on the node, i.e., container) constrains access of the containers 118 to physical resource, such as CPU, storage, and memory, so that a single container, such as container 118A, cannot take up all of a host's physical resources. A guest host operating system, on the other hand, may include instructions installed on either a virtual machine or partitioned disk that describes an operating system that is different than the host operating system. Therefore, a host operating system can be installed on a computer and interacts with underlying hardware, while a guest operating system can be located on a virtual machine.

The pods 116 included in a worker node 104 can be created, destroyed, and re-created, based on the state of the server and the service itself, and therefore may not be intended to continue to exist for a long period of time. Because of the relatively short lifespan of the pods 116, the IP address that they are served on may change, making the communication of the associated microservices difficult. Therefore, Kubernetes has introduced the concept of a service, which is an abstraction on top of a number of pods 116, such as using a proxy in order to be run on top of the services in order for other services to communicate via a virtual IP address. As a result, load balancing may be set up for numerous pods 116 so that the pods may be exposed via a service. The pods 116 can be recreated and have changes to its corresponding IP protocol. Therefore, services can be created having stable IP and DNS names, which can be used by other pods to communicate with the pod. For example, consider an image-processing backend, which is running with three replicas. Those replicas may be fungible-frontends that do not care which backend they use. While the actual pods that compose the backend set may change, the frontend clients may not need to be aware of those changes or to keep track of a list of the backends. Each of the services within the containers 118 of the cluster 110 can be assigned a domain name service (DNS) name that includes a name identifying the pod 116 within which the service resides, along with a portion of the DNS name that identifies the name of the service.

Each of the worker nodes 104 may include a node agent, such as a kubelet for example, (e.g., worker node 104A includes node agent 120A, hereinafter the node agents 120A-120N are referred to collectively as node agents 120) and a proxy, such as a kube-proxy for example, (e.g., worker node 104A includes proxy 122A, hereinafter the proxies 122A-122N are referred to collectively as proxies 122)). A node agent 120 may be in communication with the master node 102 and receives details for the configuration of the pods 116 from the API server 106. The node agent 120 uses the received details to ensure that the constructed containers 118 are operating as intended. In addition, the node agent 120 may also receive information about specific services from the storage component 124 to obtain information related to services and to create details related to newly created services.

Each of the proxies 122 function as a network proxy, or hub through which requests are transferred, and as a load balancer for a service on a single worker node 104 which acts as a reverse proxy and distributes network or operation traffic across a number of servers. The load balancer can be used to increase capacity (concurrent users) and reliability of operations and perform network routing for transmission control protocol (TCP) and user data protocol (UDP) packets. The proxies 122 may be responsible for routing traffic to the appropriate container 118 in order to enable access to services based on an IP address and numbering of an incoming request for creating an operation.

In this way, the resources of the worker nodes 104 may be combined together and identified so that when an operation or program is to be created or deployed onto the cluster 110, the program or services for creating and running the service are located throughout the individual worker nodes 104. If any of the nodes 104 are added or removed, the cluster 110 is able to create or deploy the programs or services by combining resources from different nodes 104 or using a combination of different services within the nodes 104.

In order to deploy containerized operations in a containerized management system, such as a Kubernetes system, for example, a deployment configuration for providing instructions on how to create and update services for creating a desired operation can be input to the master node 102 via a CI/CD pipeline 108, such as a kubectl command line interface for example. Once the instructions on how to create and update services for creating a desired operation have been received by the master node 102, the API server 106 of the master node 102 schedules the operation onto individual worker nodes 104 within the cluster 110 to create the operation using a combination of multiple different services within multiple different containers 118 of multiple different pods 116 of the cluster 110. In this way, the operation is created using a combination of services located in multiple containers 118 located within one or more pods 116 within one or more worker nodes 104.

Once the operation has been created and scheduled, the master node 102 continuously monitors the pods 116. If the master node 102 determines that a service used for the operation located within one of the containers 118 of the pods 116 goes down or is deleted, the master node 102 replaces the deleted or non-operating pod associated with the operation using a different combination of the currently available services within the containers 118 of the pods 116 of the cluster 110. In this way, the API server 106 monitors the functionality of the pods 116, and when the pods 116 no longer functions as intended, recreates the pod 116.

The cluster 110 may be monitored by one or more monitoring tools. Some examples of traditional monitoring tools include metric monitoring tools (e.g., Prometheus, Grafan and the like); log management systems (e.g., ELK stack or similar tools); tracing systems (e.g., Jaeger, OpenTelemetry, Zipkin, Grafan Tempo, or similar tools). In examples, the monitoring tools may store cluster observability data used to perform respective monitoring tasks in one or more data stores, shown in FIG. 1 as observability data stores 142.

In examples, metric monitoring tools collect cluster metric data from cluster 110 and stores the data to a custom database (e.g., one of observability data stores 142). As an example, Prometheus may operate by sending HTTP scrape requests to the cluster by interfacing with the API server 106. Each application returns relevant metric data back to Prometheus in response to the HTTP scrape requests. In examples, the API server 106 may return data that enables Prometheus to discover data targets, such as nodes, endpoints, services, pods, ingress. Metric monitoring tools, such as Prometheus and Grafan, may obtain any number of metrics, such as but not limited to, CPU utilization per node, per pod, and/or per container; memory usage and limits; network throughput and latency; disk input/output performance; API server response times; pod restart counts; container runtime statistics; node health status; resource quota utilization; and authentication failure rates. In the case of a Kubernetes environment, metric monitoring tools may fetch any of the known Kubernetes metrics.

In examples, log management systems collect log entry data from cluster 110 and stores such data to one of the observability data stores 142. In the case of the ELK stack, Logstash ingests, transforms, and sends the log entry data to a destination; Elasticsearch indexes, analyzes, and searches the ingested data; and Kibana visualizes the results of the analysis. The ELK stack can be used for log analytics, document search, security information and event management (SIEM), and observability. It provides the search and analytics engine, data ingestion, and visualization from log entry data.

In examples, tracing systems collect trace data from cluster 110 and stores such data to one of the observability data stores 142. A tracing system monitors how requests travel through the cluster 110, which can be used to improve performance and resource utilization. Tracing systems can help developers and operators identify issues, troubleshoot problems, and understand how components interact. Jaeger is an example of an open-source tracing system that can be deployed in a Kubernetes environment to monitor and troubleshoot services. Jaeger can be deployed as a sidecar or daemonset and can be deployed in a pod (e.g., pods 116A-N) as a Jaeger agent. A Jaeger collector receives spans from Jaeger agents. For example, a trace may refer to an end-to-end execution flow of processing an operation of a workload of a microservice, including all intermediate operations. An end-to-end execution flow of a trace is a composite of spans and their causal ordering. A span refers to a named operation with a set of attributes (e.g., duration, host/process identifier (ID)) to describe a single unit of the end-to-end execution. A Jaeger collects spans from various Jaeger agents along the execution flow to construct a trace, which can be stored to a database (e.g., one of the observability data stores 142).

The master node 102, in examples, includes a root-cause analyzer system 130 configured to provide comprehensive observability into the cluster 110 for proactive compliance driven root-cause detection within the cluster 110. In examples, the root-cause analyzer system 130 is an AI driven system that can detect anomalous events within the cluster 110, identify a root-cause of the events, and take actions to remedy the root-cause. To provide for this functionality, root-cause analyzer system 130 can be configured to train a set of ML models on historical cluster observability data, stored to observability data stores 142, to recognize technological anomalous events and identify a root-cause of the events. In some examples, root-cause analyzer system 130 may be configured to utilize the trained ML models to predict future events, for example, by recognizing anomalous patterns in the cluster observability data and predicting a future event from the patterns. To ensure data privacy and security compliance, root-cause analyzer system 130 can integrate verification of governance and security compliance criteria 148 with the root-cause analysis. For example, root-cause analyzer system 130 can leverage compliance violation detection to identify a root-cause of a technological anomalous event, as well as predicting future technological anomalous events, for example, where a compliance violation could lead to overloading of a component of entire cluster 110.

By identifying a root-cause, root-cause analyzer system 130 may be configured to take remedial actions to correct detected events and/or avoid such situations that lead can result in future anomalous events. For example, root-cause analyzer system 130 may generate an alert presented in a dashboard of a front-end system 150 operated by an administrator (or other DevOps team member). In another example, root-cause analyzer system 130 may automatically execute remedial actions, without human intervention, to resolve the root-cause. In yet another example, root-cause analyzer system 130 may generate a recommended action, which can be presented via the dashboard on front-end system 150 and the administrator (or other DevOps team member) may choose to accept or execute a different remedial action.

In examples, the root-cause analyzer system 130 may include an API gateway, which may be software or a service offered via a cloud platform hosting the root-cause analyzer system 130 as a backend system. The API gateway may allow developers to create, publish, maintain, and/or monitor APIs such as REST APIs and/or WebSocket APIs. In some examples, the API gateway may be used to publish data to an API of a dashboard of the front-end system 150 hosted on a user portal. In particular, the root-cause analyzer system 130 may communicate information associated with the root-cause analysis and remedies to the front-end system 150 via the API gateway. The API gateway publishes such information to the API of the front-end system 150, which in turn can display the information on the dashboard and provide an interaction interface for the administrator (or other DevOps team member).

In examples, root-cause analyzer system 130 can be configured to build predictive root-cause analyzer that detects technological anomalous events, which can be used to recognize anomalous patterns. Root-cause analyzer system 130 may then analyze the anomalous patterns to identify and locate a root-cause or predict future events (e.g., technological anomalous events or compliance events). In examples, root-cause analyzer system 130 may build the predictive root-cause analyzer by training an ensemble of ML models on historical cluster observability data stored to the observability data stores 142. In some examples, the ensemble of ML models may include a clustering algorithms for grouping similar events, NLP for analyzing log entry data, Bayesian Networks for training and modeling relationships between components of the cluster 110 to construct a structural topography of the cluster 110, deep learning models (e.g., Long Short-Term Memory (LSTM) or similar models) for time-series anomaly prediction from metrics, and reinforcement learning for adaptive troubling shooting. For example, root-cause analyzer system 130 may execute NLP to analyze log entry data, which represent events. The clustering algorithm may cluster similar events, which can be correlated with metric data and trace data using Bayesian Networks to train relationships between events, metrics and components. The deep learning models can be leveraged to predict future events based on the clustering and correlated data.

Root-cause analyzer system 130 can then be trained to recommend remedial actions, for example, through reinforcement learning based on an administrator (or other DevOp team member) actions as training inputs. For example, root-cause analyzer system 130 may be configured for reinforcement learning on remedial actions to provide for adaptive troubleshooting. That is, in examples, root-cause analyzer system 130 may include an agent that takes or recommends remedial actions to remedy detected root-cause and/or avoid such situations that lead can result in future anomalous events. Action can be interpreted into a reward and a state representation of the entire cluster 110, which are fed back to the agent.

In some examples, one or more remedial actions can be recommended via the dashboard on front-end system 150. In this case, an administrator (or other DevOp team member) may review the actions and provide feedback in the form of selecting one or more remedial actions for the root-cause analyzer system 130 to execute, rejecting one or more remedial actions, and/or modifying one or more remedial actions that the root-cause analyzer system 130 can execute. Once the root-cause analyzer system 130 is trained on various root-causes and remedial actions, root-cause analyzer system 130 may be able to detect a current root-cause and/or predict future issues, select an appropriate remedial action based on the knowledge gained by the reinforcement learning, and execute the remedial action to address the situation, without human intervention.

Root-cause analyzer system 130, according to various examples, can be configured to leverage governance compliance and security checks to ensure data privacy compliance, access control/authentication, and API security, to name of few. In some examples, the governance and security compliance criteria (referred to herein collective as compliance criteria 148) may be set forth as a plurality of rules, stored to a database. That is, for example, root-cause analyzer system 130 can be configured to analyze events and verify the events comply with compliance criteria 148. For example, root-cause analyzer system 130 may include one or more additional ML model trained to detect compliance violation events in cluster observability data (e.g., cluster observability data that does not satisfy one or more of compliance criteria 148) stored to the observability data stores 142. Root-cause analyzer system 130 may then be configured to correlate technological anomalous events with compliance violation events (e.g., data privacy violations, access control/authentication, API security, Audit trail requirements, secure communications, and the like) in the cluster 110. By correlating the technological anomalous events with the compliance violation events, root-cause analyzer system 130 incorporates real-time compliance evaluation into the root-cause analysis.

In examples, compliance criteria 148 may be a set of rules defining security and governance compliance requirements that the cluster 110 may be required to abide by. For example, compliance criteria 148 may comprise privacy laws promulgated by governing regulations, such as the General Data Protection Regulation (GDPR) in the cause of the European Union and the California Consumer Privacy Act in the case of California (other states may implement similar policies). Such privacy laws may define rules that the cluster may be required to abide by to ensure privacy of the users and operators of the cluster 110. These rules may be stored in a database, hosted by a third party system, in human readable natural language, which root-cause analyzer system 130 may obtain and process using NLP to extract rules from the privacy regulations and construct the compliance criteria 148. For example, in the US, the National Institute of Standards and Technology (NIST) maintains database(s) of governance compliance regulations, which can be accessed by interfacing with an API. Accordingly, root-cause analyzer system 130 obtain such regulations from a remote database via APIs.

In examples, compliance criteria 148 also include rules defining vulnerabilities of the cluster 110. For example, known vulnerabilities, such as vulnerabilities in the containers 118 residing at pods 116, may be published by third party systems. For example, the NIST maintains a National Vulnerability Database (NVD) of disclosed cybersecurity vulnerabilities, which can be accessed through an API, known as the NVD-API. Thus, similar to the governance compliance, root-cause analyzer system 130 can be configured to obtain security vulnerabilities from a third party system, which can be used to construct the compliance criteria 148.

In examples, the ensemble of ML models described above may include a first one or more ML models trained to detect technological anomalous events in the cluster 110 and a second one or more ML models trained to identify compliance violation events at one or more of the worker nodes 104. From the technological anomalous events, an anomalous pattern can be identified (e.g., a manifestation of a root-cause issue) and correlated with compliance violation events. From this correlation, root-cause analyzer system 130 can detect a root-cause of the technological anomalous events and locate the root-cause within the cluster 110. That is, for example, root-cause analyzer system 130 may detect a compliance violation event, for example, at worker node 104N that may be causing technological anomalous events experience at worker node 104A or elsewhere in cluster 110. By correlating the two, root-cause analyzer system 130 may be able to locate the root-cause of the technological anomalous events.

In examples, the ensemble of ML models may include a third one or more ML models that the root-cause analyzer system 130 can train to assign a risk score to the root-cause. That is, for example, a classification model may be trained to classify each root-cause as a risk score. This risk score can be used to rank the root-causes for prioritizing remedial actions in rectifying the root-cause.

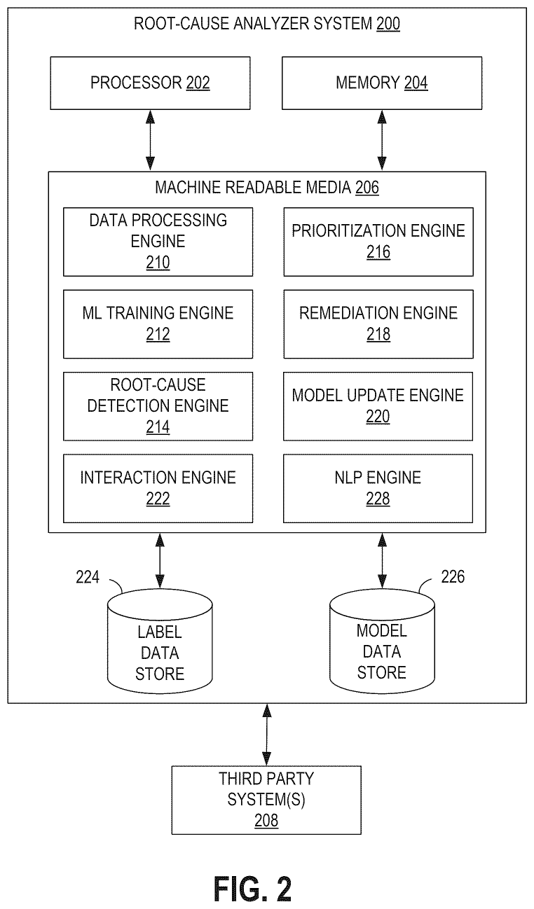

FIG. 2 depicts a schematic block diagram of an example computer system for root-cause analysis, in accordance with examples disclosed herein. FIG. 2 includes an example root-cause analyzer system 200, which may be an example implementation of root-cause analyzer system 130 of FIG. 1. In the example of FIG. 2, root-cause analyzer system 200 comprises processor 202, memory 204, and machine readable media 206. Root-cause analyzer system 200 may be a server computer that communicates via network communications to other devices accessible on the network, including, for example an API server (e.g., API server 106 of FIG. 1), worker nodes (e.g., worker nodes 104 of FIG. 1), data stores (e.g., observability data stores 142), and one or more third party systems 208. Root-cause analyzer system 200 may receive cluster observability data (e.g., metrics, log entry data, trace data, or other observability data) from worker nodes in a container management system environment (e.g., worker nodes 104 of cluster 110). Root-cause analyzer system 200 may also receive security and compliance data from third party system(s) 208.

Processor 202 may comprise a general-purpose or special-purpose processing engine such as, for example, a microprocessor, controller, or other control logic. Processor 202 may be connected to a bus, although any communication medium can be used to facilitate interaction with other components of root-cause analyzer system 200 or to communicate externally.

Memory 204 may comprise random-access memory (RAM) or other dynamic memory for storing information and instructions to be executed by processor 202. Memory 204 might also be used for storing temporary variables or other intermediate information during execution of instructions to be executed by processor 202. Memory 204 may also comprise a read only memory (“ROM”) or other static storage device coupled to a bus for storing static information and instructions for processor 202.

Machine readable media 206 may comprise one or more interfaces, circuits, and modules for implementing the functionality discussed herein. Machine readable media 206 may carry one or more sequences of one or more instructions processor 202 for execution. Such instructions embodied on machine readable media 206 may enable root-cause analyzer system 200 to perform features or functions of the disclosed technology as discussed herein. For example, the interfaces, circuits, and modules of machine readable media 206 may comprise, for example, data processing module 210, ML training engine 212, root-cause detection engine 214, prioritization engine 216, remediation engine 218, model update engine 220, interaction engine 222, and an NLP engine 228.

NLP engine 228 can be configured to understand queries in natural language (either text, images, or audio) and return responses context specific results, in natural language, relevant to the query in natural language. In examples, the NLP engine may process queries using statist linear regression, decision trees, support vector machines, neural networks, deep learning models, large language models, and/or other known approaches trained on natural language models. In some example, NLP engine 228 can be integrated with the interaction engine 222 to provide a more human-like interaction. NLP powered interaction engine 222 can be configured to assess a user query and create responses based on that are contextually relevant. Conventionally, queries have been provided to cluster monitoring systems in the form complex query (e.g., a user would write “SELECT*FROM system_logs WHERE error_code=500 AND timestamp>‘2023-09-01’”) or navigate multiple menus. Whereas, by leveraging the NLP engine 228 a query may be provided as “Show me all 502 errors from last month”. The NLP engine 228 can interpret and understand what the query is requesting and return relevant results.

Data processing module 210 may be configured to receive input data from a cluster of a container management system (e.g., cluster 110) and/or third party systems 208. For example, data processing module 210 may be configured to receive cluster observability data from an API server of a cluster, one or more worker nodes of the cluster, and/or from databases storing cluster observability data, such as observability data stores 142 (e.g., cluster observability data used by cluster monitoring tools as described above). The cluster observability data may comprise one or more of trace data, metrics, or log entry data of the cluster. In examples, data processing module 210 may also be configured to receive security and compliance data external third party systems (e.g., databases storing privacy regulations and/or known security vulnerabilities). In this case, data processing module 210 may interface with the third party systems using dedicated APIs. In some examples, the input data is ingested by collecting, receiving, and storing the input data.

In some examples, the input data received by the root-cause analyzer system 200 may be unlabeled data. For example, input data may contain a payload holding content of the data and metadata descriptive of the context of the data. For example, in the case of cluster observability data, the payload may contain metrics, traces, and/or log entries depending on the type of data, while the metadata may include a set of attributes defining characteristics of the data and sources (e.g., a timestamp, duration, process IDs, thread IDs, worker node ID or other source ID, etc.) that can identify the type of data upon analysis thereof. This is in contrast to a label that can be added by root-cause analyzer system 200, which may label the data with a class of root-cause.

In examples, data processing module 210 may be configured to ingest input data into a data processing pipeline. For example, data processing module 210 may be configured to perform one or more of the following processing operations on the raw received input data: clean the received raw input data; normalize the cleaned raw input data; perform feature scaling; and manage missing values. A cleaning operation may involve removing noise and irrelevant information from the raw input data. A normalization and feature scaling operations are two ways of converting multiple data fields into a common range. Depending on the kind of data, one or both techniques may be applied. Dealing with missing values may entail executing imputation or deletion strategies to add a missing value as an average value (or other means of estimating a missing value) or delete an instance of missing values. In examples, data processing module 210 may also be configured identify and extract relevant features from the raw input data and convert the feature-extracted data into a standardized format suitable for root-cause analyzer system 200 to provide processed input data. Data processing module 210 may utilize NLP engine 228 for performing one or more of the above operations.

As an illustrative example, consider a raw log entry received from ELK stack. The raw log entry may be: “2023-08-22T10:15:30.123Z INFO [app-server-5f7d9c7b5d-2abc] Request processed: GET /pi/users Status: 500 Duration: 2.5 s.” Data processing module 210 may be configured to process the log entry using NLP engine 228 to parse the timestamp, log level, pod name, HTTP method, endpoint, status code, and duration from the raw log entry and extract key features, such as but not limited to hour of the day, day of the week, etc. Data processing module 210 may be configured to convert the feature-extracted data to a standardized format to generate a processed input log entry. As an example, the processed input log entry may be provided as: {‘timestamp’: ‘2023-08-22T10:15:30.123Z’, ‘pod’: ‘app-server-5f7d9c7b5d-2abc’, ‘method’: ‘GET’, ‘endpoint’: ‘/api/users’, ‘status_code’: 500, ‘status_category’: ‘5xx’, ‘duration’: 2.5, ‘hour_of_day’: 10, ‘day_of_week’: 1 #Assuming Tuesday}.

As another illustrative example, consider a raw metric received from Prometheus. The raw metric may be: “node_cpu_utilization{instance=“node-1.example.com”, job=“node”, cpu=“0”} 75.5”. Data processing module 210 may be configured to process the metric using NLP engine 228 to parse the metric name, labels, and value from the raw metric. Data processing module 210 may be configured to extract features by executing certain functions the metric, such as aggregation of metric over a time window (e.g., 5-minute average) and calculating a derived metric (e.g., CPU saturation in this example). The values and extracted features may be normalized and converted to the standardized format. As an example, the processed input metric may be provided as: {metric’: ‘node_cpu_utilization’, ‘instance’: ‘node-1.example.com’, ‘cpu’: ‘0’, ‘value’: 75.5, ‘timestamp’: ‘2023-08-22T10:15:00Z’, ‘5min_avg’: 72.3}.

As yet another example, consider a raw trace received from Jaeger. The raw trace may be: {“traceID”: “abc123”, “spans”: [{“spanID”: “span1”, “operationName”: “HTTP GET”, “startTime”: 1629626130000000, “duration”: 50000, “tags”: [{“key”: “http. status_code”, “value”: 200}, {“key”: “component”, “value”: “nginx”}]}, {“spanID”: “span2”, “operationName”: “Database Query”, “startTime”: 1629626130010000, “duration”: 30000, “tags”: [{“key”: “db.type”, “value”: “mysql”}, {“key”: “db.statement”, “value”: “SELECT*FROM users”}]}]}. Data processing module 210 may be configured to process the trace using NLP engine 228 to extract the relevant information from spans and calculate derived metric (e.g., service dependencies, error rates, etc.). The values and extracted features may be normalized and converted to the standardized format. As an example, the processed input trace may be provided as: {‘trace_id’: ‘abc123’, ‘total_duration’: 50000, #microseconds, ‘span_count’: 2, ‘services_involved’: [‘nginx’, ‘mysql’], ‘error_occurred’: False, ‘bottleneck_service’: ‘Database Query’, ‘bottleneck_duration_percent’: 60.0, ‘has_db_operation’: True}.

In examples, data processing module 210 may be configured to construct compliance criteria (e.g., compliance criteria 148 of FIG. 1) from security and governance compliance requirements that a cluster may be required to abide by. For example, data processing module 210 may ingest privacy governance regulations and/or security vulnerabilities from third party system(s) 208 via corresponding APIs (e.g., NVD-API or similar APIs for accessing respective databases). Data processing module 210 may then execute NLP engine 228 on the obtained data to parse data and extract features, such as the requirements, values, and related components of the cluster. The extracted features may then be used to define a set of rules, which are included in compliance criteria and stored to label data store 224.

In some examples, data processing module 210 may be configured to update compliance criteria periodically or automatically responsive to an update in the security and governance compliance requirements maintained on third party systems 208. In one example, data processing module 210 may periodically check the third party systems via REST commands over the corresponding API to request updates in the security and governance compliance requirements. In an example, data processing module 210 may check every 15 days or other amount of time as desired for a given application. If data processing module 210 identifies an update to the security and governance compliance requirements, data processing module 210 may process the updated security and governance compliance requirements to update the compliance criteria stored to the label data store 224. In another example, data processing module 210 may continuously monitor the third party systems 208 and automatically update the compliance criteria upon detecting an update to the security and governance compliance requirements. In some examples, data processing module 210 may alert an administrator (or other DevOp team member) of any updates to the security and governance compliance requirements prior to updating compliance criteria, and update compliance criteria upon confirmation from the administrator (or other DevOp team member).

ML training engine 212 may be configured to train an ensemble of unsupervised and/or supervised ML models. For example, ML training engine 212 may be configured to train supervised models, in which the models are trained to make distinctions between labeled training data sets and unlabeled training data sets. This training allows the models to recognize events that depart from expected operations, identify patterns, and ultimately operate autonomously without using labels. In examples, historical cluster observability data may be used as training data, which may be labeled with root-causes or unlabeled. In either case, the ML models trained by the ML training engine 212 may comprise a number of models trained for root-cause predictions.

Various training methods are described herein and implementation of any of these training methods will not divert from the essence of the disclosure.

In some examples, an unsupervised ML model may correspond with clustering (e.g., k-means, hierarchical clustering), dimensionality reduction (e.g., PCA, t-SNE), association rule learning, or other unsupervised ML models, as known in the art. Unsupervised ML models may be trained on training data sets of unlabeled data to assign or generate a label for the unlabeled training data. The label determined during the training process may be stored in label data store 224.

As noted above, ML training engine 212 may also be configured to train a supervised ML model. The supervised ML model may be trained using training data sets of labeled data that was determined from the unsupervised ML model and/or an operator and stored in label data store 224. In some examples, the supervised ML model may correspond with linear regression, decision trees, support vector machines, neural networks, deep learning models, or other supervised ML models.

Training the supervised or unsupervised ML model may begin by initializing the model with random or predefined parameters that can be adjusted during the training. When a label that is determined, the ML training engine 212 may iteratively adjusts parameters of the model to minimize the difference between its predictions and true labels. In some examples, a loss function may also be implemented to quantify the error between the predicted outputs and the true labels. The loss function may be minimized during training.

In some examples, an optimization function can be implemented to adjust the parameters of the model iteratively. An illustrative process to adjust the parameters is gradient descent, although various optimization functions may be implemented. In some examples, the gradient of the loss function may be calculated with respect to the model parameters. The parameters may be updated in the opposite direction of the gradient to minimize the loss.

The trained ML model may be stored in a model data store 226 as trained ML models. The trained ML models may be used during an analysis process at run-time when new unlabeled data is received by root-cause analyzer system 200.

In an example, the ML training engine 212 may be configured to train a plurality of sets of ML models that collectively make up the ensemble of models. A first set of ML models may be trained on historical cluster observability data (e.g., obtained from observability data stores 142, API server 106, and/or worker nodes 104) to detect technological anomalous events in a cluster (e.g., cluster 110). The first set of ML models may comprise, for example, supervised or unsupervised ML models. As an illustrative example, the first set of ML models may include a deep learning model trained on cluster observability data classified as either anomalous or non-anomalous (e.g., normal). Through training, the first set of ML models can learn how to distinguish technological anomalous events from normal or non-anomalous operation.

The plurality of sets of ML models may include a second one or more ML models trained to identify compliance events at one or more of the worker nodes. For example, the second one or more ML models may include a PII detection model trained to identify PII in cluster observability data. In this case, the PII detection model may include a named entity recognition (NER) model that is trained on labeled cluster observability data to identify names, address, emails, or other PII within cluster observability data. What is considered PII may be defined according to the set of rules contained in compliance criteria and the cluster observability data may be labeled to identify which elements are PII. The PII detection model may also include a regular expressions model trained to detect patterns in the text of the cluster observability data, such as but not limited to, email address, phone numbers, credit card numbers, social security numbers, and the like. A classification model (also referred to as a PII classification model) can be included that is trained to classify data elements of the cluster observability data based on a probabilistic determination of the data element being PII. That is for example, the NER and regular expression model may be executed to identify data elements of concern (e.g. names, address, etc.) in cluster observability data, which can be supplied to the classification model as inputs. The classification model can be configured to classify each data element as being PII or not, with a probabilistic confidence score of the classification being correct or not. The classification model may then generate a label for each data element according to the classification.

As another example, the second one or more ML models may include a vulnerability detection model trained to identify security vulnerabilities in cluster observability data. Similar to the above, an NER may be trained to identify data elements from cluster observability data that are candidates for classification, such as APIs, endpoints, services, pods, ingress, and the like. The identified data elements can be supplied to a classification model trained to label data elements as known vulnerabilities, along with a probabilistic confidence score of the classification being correct or not.

Examples herein may implement various confidence scores. For example, a confidence score may be determined for each classification and the greatest confidence score associated with the particular class may determine which class the input data are assigned. In other examples, if a confidence score for a class exceeds a predetermined threshold (e.g., 0.5 or 50%), the ML models might predict it as the belonging to the class. Otherwise, the ML model may predict the opposite (e.g., the input data does not belong to the class). In this sense, the thresholding of the confidence score may be used for classification.

The ensemble of ML models may include a third one or more ML models trained to identify a root-cause of technological anomalous events. For example, the third one or more ML models may be trained to identify an anomalous pattern (e.g., a manifestation of a root-cause issue) from training data including anomalous and non-anomalous historical cluster observability data. The third one or more ML models may include clustering algorithms (e.g., k-means, DBSCAN, hierarchical clustering, and the like) configured to group similar events in the training data. Bayesian Networks may also be included for training and modeling relationships between containers, pods, and nodes of the cluster to construct a structural topography of the cluster. The Bayesian Networks may utilize cluster observability data, such as trace data, to construct the structural topography through relationship contained in the trace data. A deep learning model may then be applied to the training data to identify anomalous patterns (e.g., anomalous event clusters from the clustering algorithms) and locate the root-cause of the within the structural topography provided by the Bayesian Networks. The deep learning model may also be configured to classify the root-cause according to a class of root-cause types.

In examples, compliance events may be integrated into the ML models trained to identify a root-cause of the technological anomalous events. For example, a compliance event classified by the second one or more ML models can be correlated with an anomalous pattern, for example, using timestamps and other identifying information. From this correlation, the third one or more ML models can detect a root-cause of the technological anomalous events and locate the point along the execution flow, within the cluster (e.g., cluster 110), of the root-cause. That is, for example, a compliance event may be identified at worker node that may be causing technological anomalous events experienced at another worker node or elsewhere in the cluster. By correlating the two, the root-cause of the technological anomalous events may be located as the compliance event. Without such correlation, the compliance event may not be recognized as having a technological impact alone, and root-cause of the technological anomalous event may miss classified as the location of the technological anomalous event itself, which may merely be a manifestation of the compliance event.

The root-cause detection engine 214 may be configured to initiate a root-cause analysis (e.g., during a run-time) by applying new input cluster observability data to the ensemble of trained ML models stored to the model data store 226. The trained ML models may make predictions on new unlabeled input cluster observability data. For example, once the ML model are trained, the ML models stored in model data store 226 can be deployed for detecting and locating root-cause of technological anomalous events in the new input cluster observability data. In examples, the trained ML models may be able to recognize anomalous patterns from anomalous events, which can be used to predict or otherwise forecast issues, as well as locate a root-cause prior to more significant issues. For example, in one case, root-cause detection engine 214 may be reactive such that root-cause detection engine 214 can apply the trained ML models to detected events and explore the cluster (e.g., entire cluster 110) for a root-cause of these event. In another case, root-cause detection engine 214 may be proactive such that root-cause detection engine 214 may recognize a growing anomalous pattern (which may or may not yet trigger technological anomalous events) and apply the trained ML models to predict future events that may negatively impact cluster performance in the future.

In examples, compliance events can be integrated into the analysis to further inform the root-cause analysis. For example, root-cause detection engine 214 may be configured to analyze events and verify the events comply with compliance criteria (e.g., compliance criteria 148). For example, root-cause detection engine 214 may leverage the second one or more ML models trained to detect compliance violation events from cluster observability data (e.g., cluster observability data that does not satisfy one or more of compliance criteria 148). Root-cause detection engine 214 may then be configured to correlate technological anomalous events with compliance violation events (e.g., data privacy violations, access control/authentication, API security, Audit trail requirements, secure communications, and the like) in the cluster 110. By correlating the technological anomalous events with the compliance violation events, root-cause analyzer system 130 incorporates real-time compliance evaluation into the root-cause analysis. As another example, root-cause detection engine 214 may detect compliance violation events and recognize a growing anomalous pattern as an increasing occurrence of such events. Root-cause detection engine 214 may utilize the trained ML models to correlate the anomalous pattern with a potential impact on the technological operation of the cluster, which can be flagged for remedial actions.

In examples, prioritization engine 216 comprises one or more ML models trained to assign a risk score to root-causes identified by the root-cause detection engine 214. The risk score can be used to rank the detected root-cause against other root-causes for prioritizing remedial actions in rectifying the root-cause. In examples, prioritization engine 216 may include, but not limited to, decision tree models, random forest models, classification models, and the like, trained to learn patterns between cluster observability data and high-risk events. In examples, prioritization engine 216 can be trained using labeled training data in which historical cluster observability data and/or root-causes are labeled with a corresponding risk score. In decision tree models, the third one or more models may receive the training data sets as input and process it through decisions boundaries. The similarities between the output (e.g., a risk score) may be determined and features of labeled root-cause can be used to adjust model parameters (e.g., decision boundaries).

In examples, the risk scores may be multi-dimensional in that a given risk score is provided that balances multiple characteristics of a root-cause. For example, a risk score may be determined based on or more of a severity, frequency, and context. Each technological anomalous event and/or compliance event may have a baseline severity level or risk score assigned to it. That is, for example, a given event may be associated with a particular risk score indicative of the impact the event may have on operations of the cluster (e.g., does the root-cause cause the cluster or components to become non-operational, consume increasing amounts of computation resources, etc.). For example, 5xx errors may have a relatively low baseline score, while unauthorized access to PII may have a relatively high baseline score. The frequency may indicate a rate at which the event is occurring (e.g., number of occurrence within a time window). The context may provide when, where and how the event is performed within the cluster. Thus, for example, a low severity/baseline score may be increased where the frequency of occurrence is relatively high and the context places the events at a sensitive endpoint. Similarly, a high baseline score may be lowered where the occurrence as infrequent and the context is not sensitive.

Take an example of a security breach due to an insecure API endpoint. In this example, assume a log entry for one API of a worker node is received by data processing module 210 as: 2023-08-22T10:15:30.123Z WARN [api-server-7b9d4f5c8-36] Request processed: GET /pi/users/export Status: 200 Duration: 1.5 s IP: 203.0.113.42. data processing module 210 may execute data processing operation, as described above, to provide a processed input log entry: ‘log_entry’: {‘timestamp’: ‘2023-08-22T10:15:30.123Z’, ‘pod’: ‘api-server-7b9d4f5c8-36’, ‘method’: ‘GET’, ‘endpoint’: ‘/api/users/export’, ‘status_code’: 200, ‘duration’: 1.5, ‘ip’: ‘203.0.113.42’}. The processed input log entry may be provided to the root-cause detection engine 214, which applies the first one or more trained ML models to the processed input log entry to classify the processed log entry as an anomalous event.

The root-cause detection engine 214 may then apply the second one or more trained ML models to the log entry to perform a compliance check. In this example, the compliance check is returned as: ‘compliance_checks’: [{‘check’: ‘sensitive_data_access’, ‘result’: ‘warning’, ‘details’: ‘Sensitive endpoint accessed. Verify authorization.’}, {‘check’: ‘unusual_traffic_pattern’, ‘result’: ‘alert’, ‘details’: ‘Unusual access pattern detected for this IP.’}. As illustrated above, the root-cause detection engine 214 references the compliance criteria to determine which compliance checks to perform and then evaluates the processed log entry data to label data elements as “warning” or “alert.” Root-cause detection engine 214 also generates a detail entry that provides additional context to the result, which may utilize generative AI models and NLP engine 228.

The processed log entry and compliance check results can be provided prioritization engine 216 to label the resulting analysis with a risk score. For example, prioritization engine 216 may classify the root-cause as having a risk score of 6.5 out of 10, with 10 being a high risk (e.g., high priority) and 0 being a low risk. While a 10 point scale is used as an example here, other values may be used as desired for a given application. For example, prioritization engine 216 may determine that this compliance event has a “high severity” due to a sensitive nature of the “/api/users/export” endpoint and the Bayesian Networks of the root-cause detection engine 214 may indicate a high probability of risk given the combination of endpoint and unusual IP address.

The remediation engine 218 may be configured to remedy a root-cause by taking remedial actions constructed to address the root-cause. For example, remediation engine 218 may be configured to generate an alert presented in a dashboard of a front-end system operated by an administrator (or other DevOps team member). In another example, remediation engine 218 may automatically execute remedial actions, without human intervention, to resolve the root-cause. In this case, NLP engine 228 may execute remedial actions according to the prioritization set by prioritization engine 216 (e.g., execute actions for addressed events according to a ranking from high risk score to low risk score). In yet another example, remediation engine 218 may generate a set of recommended actions, which can be presented via the dashboard on front-end system for deciding which action to take by an administrator (or other DevOps team member). In this case, the recommended actions may be ranked according to risk scores of corresponding issues.

In some examples, remediation engine 218 may be configured to generate software code tailored to a root-cause detected by root-cause detection engine 214. In some examples, remediation engine 218 may be trained to recognize patterns in successful code changes made by an administrator (or other DevOps team member) and correlates the code changes with root-causes that the code changes solved. When root-cause detection engine 214 detects a similar root-cause, remediation engine 218 may recommend and/or automatically deploy similar code changes to address the root-cause. For example, root-cause detection engine 214 may detect a container crash and remediation engine 218 may suggest increasing a memory limit based on patterns learned from prior fixes.

In some examples, remediation engine 218 may be configured to execute generative AI model trained to generate code snippets tailored to a root-cause detected by root-cause detection engine 214. The generative AI model may be trained on configurations of clusters of the container management system and best practices, as well as prior code changes for solving root-causes. Thus, when a root-cause is detected by root-cause detection engine 214, remediation engine 218 may recognize a pattern and leverage the trained generative AI model to generate a custom code snippet tailored to the detected root-cause. In some examples, the generated code snippet may be deployed automatically within a cluster (e.g., cluster 110). In another example, the code snippet may be supplied to the administrator (or other DevOps team member) for review and confirmation, prior to deployment. As an illustrative example, assume root-cause detection engine 214 detects a misconfiguration in a cluster deployment that could lead to resource exhaustion. In this case, remediation engine 218 may analyze a current context, such as but not limited to, a current cluster configuration, the root-cause or requirements, system performance metrics, and compliance requirements. Remediation engine 218 may apply the issue and context of the cluster to an NLP engine 228 that interprets the issue and context and a generative AI model that generates a code snippet that corrects the misconfiguration according to learned patterns and best practices.

In some examples, the code snippet may be generated according to a code generation process. The code generation process may include prompt construction, token-by-token generation, post processing, and safety measure verifications. Prompt construction may include constructing a prompt of the specific task or issue to be addressed, a prompt of relevant context from the current system state, and a prompt of any constraints or requirements. Token by token generation may include generating, by the generative AI model, the code snippet token-by-token by considering the prompts (e.g., via prompt engineering and NLP engine 228), any previously generated tokens, and learned patterns from training data, such as prior code snippets tailored to similar root-causes. Post processing may include, after generating the initial code snippet, syntax checking, linting for best practices, and compatibility verification with the current system. Safety measure can be verified by generating code in a secure environment isolated from the cluster (e.g., cluster 110), analyzing the generated code snippet for security and compliance risks, and (optionally) reviewing the code snippet by the administrator (or other DevOps team member) prior to deployment.

Model update engine 220 may be configured to review root-cause analysis by the root-cause detection engine 214 and update the ML models based on the outputs. For example, root-causes identified during the root-cause analysis executed by root-cause detection engine 214 may be provided back to the ML training engine 212 to retrain the ML models during a subsequent training process. The retrained ML models may be stored in model data store 22s and/or provided for future root-cause analysis on new input cluster observability data samples received from, for example, cluster 110.

In examples, model update engine 220 may be configured for reinforcement learning (RL) on remedial actions to provide for adaptive troubleshooting. For example, model update engine 220 may develop an RL agent that take or recommend remedial actions for remedying detected root-causes. The actions can be interpreted into a reward and a state representation, which can be fed back to the RL agent, as known in the art. In this way, the model update engine 220 may be configured to adapt remedial actions and troubleshooting strategies based on effectiveness of prior remedies applied to similar root-causes. The prior remedies may be those executed by the remediation engine 218 and/or remedies by an administrator (or other DevOps team member) given a state of the cluster and root-cause. As an illustrative example, referring to the above security breach due to an insecure API endpoint example, the RL agent might recommend “BLOCK IP” action based on the current state. In some examples, the remediation engine 218 may execute the recommendation by blocking the IP, while in others the recommendation may be provided presented for consideration by an administrator (or other DevOps team member).

The interaction engine 222 may be configured to provide a user interface (UI) that can be used by the administrator (or other DevOps team member) to interact with the root-cause analyzer system 200. In examples, interaction engine 222 may include an API gateway configured to publish information to the API of a front-end system 150, which in turn can display the information on graphical user interface (GUI) generate at a dashboard of the front-end system. In this case, the dashboard on the front-end system may be hosted on a user portal provided by the root-cause analyzer system 200. In examples, the GUI may generate a graphical visualization that displays a structural topography of the cluster (e.g., cluster 110) and any issues, either technological anomalous events, compliance events, and/or root-causes, that are detected by root-cause analyzer system 200. In some examples, the administrator (or other DevOps team member) may input remedial actions into root-cause analyzer system 200 via interaction engine 222, which provides such actions to the remediation engine 218 for execution. In some examples, remediation engine 218 may provide recommended remedial actions to the interaction engine 222, which presents such actions to the administrator (or other DevOps team member) who can select or modify the actions. In some examples, whether based on input at interaction engine 222 or where the remediation engine 218 automatically executes a remedial action, interaction engine 222 may display the results such that the administrator (or other DevOps team member) can monitor the cluster and ensure the actions remedied the root-cause.

In examples, the graphical visualization generated by the interaction engine 222 may provide details showing inter-component relationships, probabilities of root-causes, and probabilities of remedial actions selected to address the root-causes. For example, referring to the above security breach due to an insecure API endpoint example, the RL agent of remediation engine 218 may recommend “BLOCK IP” action, which can be presented to the administrator (or other DevOps team member) via interaction engine 222. The remedial action may be displayed on the visualization with a probability that the remedial action will address the root-cause, along with displaying inter-component relationships, technological anomalous events, and/or compliance events, along with root-cause (including a probability that the root-cause will be remedied by the remedial action). The administrator (or other DevOps team member) may be provided with a decision tree based on whether to block the IP or permit the access to proceed based on the above scenario. The administrator's (or other DevOps team member's) decision may be feed back to the RL model of the remediation engine 218, along with a reward derived from the results of decision, to improve decision making process of remediation engine 218.

As an illustrative example of the graphical visualization, the GUI may display the structural topography of a cluster, with all the pods running, and where any detected issue are within the structural topography (e.g., technological and/or compliance issues). For example, a visual attribute can be applied to certain components (e.g., node, pod, container, etc.) in the cluster that are experiencing some form of issue. The visual attribute may be configured to draw attention to the components and indicate that there root-cause analyzer system 200 detected a technological anomalous event, a compliance event, and/or a root-cause at the components. The type of visual attribute may be varied between types of components and type of events (e.g., technological, compliance, or root-cause related), as well as severity and frequency of events (e.g., repetitive events). The visual attribute may include highlighting the component with a desired color (e.g., yellow, red, etc.), hatching, a border (either static or pulsing) surrounding the comment, or any other visual attribute selected to draw attention to the component. Through this visualization, an administrator (or other DevOps team member) can gain a visual perspective that can be easily navigated to not only recognize where issues are occurring but also understand a root-cause and implement remedial actions.

In some examples, interaction engine 222 may be configured for visualize issue spotting via the GUI. For example, the graphical visualization generated by the interaction engine 222 may include a time slider that can be utilized to view prior and future states of the cluster (e.g., cluster 110). For example, the graphical visualization may display a structural topography of a cluster and visual attributes indicative of the state of the cluster (e.g., detected issues) for a given point in time. An administrator (or other DevOp team member) may interact with the time slide to “rewind” the graphical visualization to display a prior structural topography and cluster state. Such functionally may permit an administrator (or other DevOp team member) to visualize how a small issue at some prior point in time grew to affect other components of the cluster over time. Conversely, an administrator (or other DevOp team member) may “fast forward” the structural topography to a future point in time to visualize how a small issue grew to affect other components. In some examples, the “fast forward” function may reflect actual cluster states, for example, such as when fast forwarding from a historical point in time to a current point in time. In another example, the “fast forward” function may utilize predicate root-cause analysis functionality in which a small issues may be detected at a current point and root-cause analyzer system 200 utilizes root-cause detection engine 214 to predict how the detected issue may grow by applying the current issue to the trained ML models in the model data store 226. In this case, the administrator (or other DevOp team member) may utilize the time slider to visualize the impact of a detected issue to determine or evaluate a prioritization of remedying the issues. The administrator (or other DevOp team member) determined prioritization may be used to evaluate a risk score provided by prioritization engine 216.

Following are various illustrative examples of the analysis and remedial actions that root-cause analyzer system 200 may be configured to address.

In some examples, the root-cause detection engine 214 can be configured for data privacy compliance checks according to compliance criteria (e.g., compliance criteria 148). In these examples, data processing module 210 may receive new input cluster observability data and process the data according to the processing pipeline described above. The root-cause detection engine 214 may apply the processed input cluster observability data to the second one or more ML models (e.g., the PII detection model) to check if an API or other endpoint in the cluster (e.g., cluster 110) is accessing or returning PII. For example, log entry data may contain API requests and associated data payloads. The root-cause detection engine 214 may apply a NER model - trained as described above-to identify names, address, etc. in data elements of the log entry data; regular expression model to detect patterns in data elements and recognize email addresses, phone number, credit card numbers, social security numbers, or the like; and the PII classification model to label each data element as PII or not using a probabilistic determination. As described above, the PII classification model may be trained on the compliance criteria (e.g., compliance criteria 148) that may define what information is PII and the PII classification models processes the extracted data elements to characterize the data elements as PII or not according to the compliance criteria. For each data element characterized as containing PII, remediation engine 218 may trigger a compliance alert that can be published by interaction engine 222 at the front-end system, the compliance alert may highlight potential PII violations due to unauthorized or unprotected PII access. In another example, remediation engine 218 may block access to the PII and/or scrub the PII from the cluster observability data prior to access.

In another example, the root-cause detection engine 214 can be configured to verify proper data anonymization techniques are applied when logging user-related data. For example, log entries may include anonymized user data and the root-cause detection engine 214 may analyze the log entries for any residual PII contain in the anonymized user data. In this case, anonymized and related original, non-anonymized data may be used for training, which are compared together and then against known PII as set forth in the compliance criteria. When new input log entry data is received, the data is processed by data processing module 210 and applied to the PII detection model (e.g., as described above) to compare the anonymized data against learned PII patterns. If residual PII is detected, remediation engine 218 may flag the log entry as a compliance event, which can be displayed via interaction engine 222. The remediation engine 218 may also recommend (or automatically apply) stronger anonymization methods or data masking to ensure privacy compliance.

In yet another example, root-cause detection engine 214 may be configured for access control and authentication verification. For example, root-cause detection engine 214 may be configured to analyze a frequency and pattern of 5xx errors on sensitive endpoints (e.g., APIs, users, and other endpoints that are to be protected against unwarranted access), and remediation engine 218 may then flag potential brute-force attempts if there is a high rate (e.g., above a set threshold, such as, but not limited to, 100 failed attempts within one minute) of failed requests from the same source. More particularly, log entries may record 5xx errors, including timestamps, endpoints, and source IP addresses, while metrics may reflect API request rates and response times. The root-cause detection engine 214 may apply the log entries and metrics to the first one or more ML models to detect 5xx errors at a particular endpoint as technological anomalous events. The root-cause detection engine 214 may identify an anomalous pattern where there is an unusual pattern or spike in 5xx error rates, as compared to expected operations, which may involve a baseline threshold of 5xx errors. The anomalous pattern may represent a sudden surge of 5xx errors at the endpoint, which may be reflected of a brute force attempt to gain access or overload the endpoint. The anomalous pattern may simply be the sudden surge of 5xx errors alone, or may include that the 5xx errors are sourced from one or more source IP address. The compliance criteria may specify certain endpoints as sensitive, such as an API handing user authentication, or as vulnerabilities. Root-cause detection engine 214 may identify the unusual pattern or spike and correlate the spike with the compliance criteria that the endpoint is a sensitive endpoint. Remediation engine 218 may then flag the endpoint as a potential security risk, which can be displayed via interaction engine 222. Remediation engine 218 may also trigger alerts for investigation, suggesting possible causes like a DDoS attack or an application vulnerability. In some examples, remediation engine 218 may execute actions without human intervention, for example, by blocking the source IP address.

In examples, root-cause detection engine 214 may also correlate the above example checks with other incidents (e.g., technological anomalous events and/or compliance events) to identify broader patterns. For example, similar occurrence may be experienced at multiple endpoints. Correlating the occurrences across the cluster may reflect that the issues is not limited to a single endpoint or source IP, but due to some other attach or failure. In the case of accessing PII, correlating such occurrence may and using trace data to trace relationships between components can be used to pin point a component of the cluster that is failing to adequately protect PII. Whereas, without such correlation, an administrator (or other DevOps team member) may consider each instance of PII access as isolated events at each component and thus fail to adequately address the root-cause.

As another example, root-cause detection engine 214 may be configured to ensure that access to sensitive endpoints are properly logged according to audit trail requirements, set forth in compliance criteria. For example, requests and access to sensitive endpoints handling user data may need to be logged for audit purposes, according to governance compliance. In this example, data processing module 210 collects and parses log entry data, and root-cause detection engine 214 checks if log entries exist for access to sensitive endpoints. For example, root-cause detection engine 214 checks a log entry for data elements of a timestamp, user ID or service account, endpoint accessed, HTTP method (e.g., GET, POST, etc.), request parameters sanitized to remove sensitive data), and response status code. If a log entry is missing, is incomplete, or deviates from expected data elements, remediation engine 218 may generate a flag indicating a compliance event that fails to satisfy the compliance criteria.

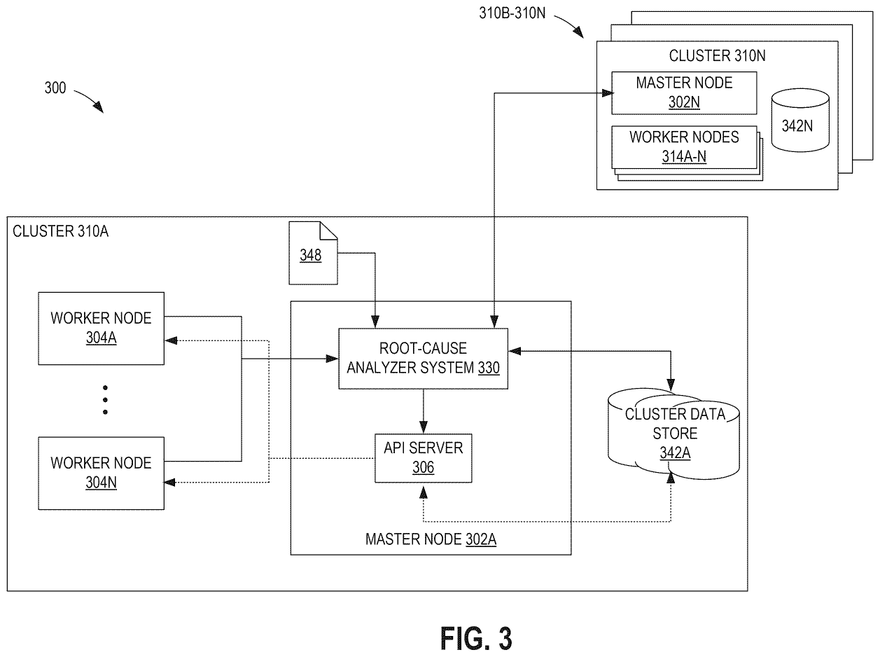

FIG. 3 is schematic diagram illustrating a container management system 300, according to an example consistent with the present disclosure. As illustrated in FIG. 3, the container management system 300 includes a plurality of clusters 310A-310N (collectively referred to herein as clusters 310), with each cluster being located remotely from other clusters. In the example of FIG. 3, the plurality of clusters 310 can be configured for federated learning to train models across multiple clusters, while maintaining data privacy.

Each of the clusters 310 may be substantively similar to cluster 110 of FIG. 1. For example, each cluster 310 may include a master node 302A-302N (hereinafter referred to collectively as master nodes 302) responsible for managing the respective cluster 310 via a respective API server (such as API server 306 of worker node 302A) and multiple worker nodes within which services of the respective cluster 310 operate. For illustrative purposes, cluster 310A is shown comprising worker nodes 304A-304N (collectively referred to herein as worker nodes 304) and cluster 310N is shown comprising worker nodes 314A-314N. Each of the cluster 310 may also comprise one or more observability data stores 342A-342N (collectively referred to herein as observability data stores 342), which may store cluster observability data used to perform respective monitoring tasks (e.g., metrics, trace data, and log entry data) of a respective cluster. For example, observability data stores 342 may be substantively similar to cluster data stores 142 of FIG. 1. In examples, master node 302A may be communicably connected to a front-end system, such as front-end system 150 of FIG. 1.

Furthermore, each of the cluster 310 may include a root-cause analyzer system 330 configured to provide comprehensive observability into each respective cluster 310 for proactive compliance driven root-cause detection within the respective cluster 310. Thus, the root-cause analyzer system 330 may be substantively similar to root-cause analyzer system 130 and/or root-cause analyzer system 200 described above in connection with FIGS. 1 and 2. In the example of FIG. 3, only cluster 310A is shown comprising a root-cause analyzer system 330; however, each of clusters 310B-310N may also comprise its own respective root-cause analyzer system.

The root-cause analyzer system 330 may be configured for federated learning, in which each cluster 310B-310N contributes data for training models of the root-cause analyzer system 330. For example, as described above in connection with FIGS. 1 and 2, root-cause analyzer system 330 can be configured to train a set of ML models to identify a root-cause by recognizing technological anomalous events and, in some examples, correlating such technological anomalous events with compliance events. In the example of FIG. 3, the root-cause analyzer system 330 of cluster 310A may be configured to obtained cluster observability data from one or more of clusters 310B-310N by interfacing with AP servers of one or more respective master nodes. For example, cluster 310A in FIG. 3 may obtain cluster observability data from cluster 310N (as well as other clusters) via an AP server of master node 302N. Accordingly, root-cause analyzer system 330 can train its set of ML models on historical cluster observability data that is stored to observability data stores 342A, as well as obtained from other cluster, to recognize technological anomalous events and identify a root-cause of the events. The root-cause analyzer system 330 can integrate verification of governance and security compliance criteria 348 with the root-cause analysis, as described above in connection with FIGS. 1 and 2.

In some examples, root-cause analyzer system 330 may leverage federated learning to obtain models trained by a root-cause analyzer system of one or more other clusters 310B-310N. For example, cluster 310N may be deployed prior to cluster 310A and master node 302A may comprise a root-cause analyzer system that is already trained for root-cause analysis in accordance with the examples of FIGS. 1 and 2. In this case, root-cause analyzer system 330 may leverage federated learning to obtain trained models from cluster 310N. In this way, root-cause analyzer system 330 may be able to initiate root-cause analysis upon initialization, without a delay in time needed to train models from scratch. In some examples, root-cause analyzer system 330 may be configured to update the pre-trained models, for example, using model update engine 220 as described above in connection with FIG. 2.

In some examples, root-cause analyzer system 330 may be configured to maintain privacy during federated learning. For example, root-cause analyzer system 330 may be configured to train its ML models using encrypted cluster observability data, without decrypting the cluster observability data. By keeping the data encrypted, root-cause analyzer system 330 can leverage cluster observability data from other remote clusters without sharing sensitive information. For example, root-cause analyzer system 330 may be configured to perform cryptographic operations on encrypted cluster observability data that enable secure computation on encrypted data. Examples of cryptographic operations includes, but are not limited to, Homomorphic Encryption, Secure Multi-Party Computation, and the like. These operations can allows root-cause analyzer system 330 to perform mathematical operations on encrypted logs, metrics, and traces, enabling root-cause analyzer system 330 to detect patterns and anomalies while preserving data privacy. For example, portions of the cluster observability data, such as the sensitive information (e.g., PII, sensitive API/endpoints, or other sensitive information) contained in the cluster observability data, may be encrypted to maintain privacy, leaving the other information unencrypted. As a result, the encrypted cluster observability data may contain generic information, which can be used to detect anomalous events and learn patterns from the encrypted cluster observability data. Such techniques may be integrated into one or more of a data processing module (e.g., data processing module 210) or ML training engine (e.g., ML training engine 212).

In some examples, clusters can select parts of its cluster observability data or trained models for sharing with other clusters. For example, cluster 310N may select certain portions of its cluster observability data and/or models for sharing with root-cause analyzer system 330. As an illustrative example, a cluster operated by a bank may select to share insights about general transaction patterns, while keeping its proprietary fraud detection methods private.

Below are some example scenarios that integrates the federated learning techniques described in connection with FIG. 3 with other functionality described in connection with FIGS. 1 and 2.

In one example, a root-cause analyzer system (e.g., root-cause analyzer system 330 and/or root-cause analyzer system 130) may be configured for resource allocation optimization. In this example, an interaction engine (e.g., interaction engine 222) may generate a predictive visualization that shows potential memory shortage in one or more specific pools of nodes of a cluster (e.g., cluster 110 and/or cluster 310A), detected by a root-cause detection engine (e.g., root-cause detection engine 214), over the next 24 hours. Based on historical data and current trends, a remediation engine (e.g., remediation engine 218) may generate suggestions updating a Pod Autoscaler configuration. Root-cause detection engine 214 may check the proposed changes against compliance rules, ensuring they do not violate data residency requirements. Using an NLP engine (e.g., NLP engine 228) querying capability in the interaction engine, an administrator (or other DevOp team member) may ask: “What's the impact of this change on our cloud costs?”. The root-cause analyzer system may execute root-cause detection engine 214 to obtain cost data (e.g., log entry and/or metrics) from other clusters (e.g., cluster 310N) to provide an estimate of potential savings. The administrator (or other DevOp team member) may then approve the change, preventing a potential outage and optimizing resource usage. The successful outcome can be fed back into root-cause analyzer system via model update engine 220 to update the ML models, improving future recommendations.

In another example, a root-cause analyzer system (e.g., root-cause analyzer system 330 and/or root-cause analyzer system 130) may be configured for addressing a security vulnerability. In this case, root-cause analyzer system may execute ML training engine 212 to train its models about a new security vulnerability affecting a container image version using compliance criteria obtained from either other clusters (e.g., federated learning) and/or third party systems. The compliance criteria (e.g., compliance criteria 148 and/or compliance criteria 348) may be updated to include these new vulnerabilities and root-cause detection engine (e.g., root-cause detection engine 214) may flag instances of this vulnerable image and prioritize them as high-risk via prioritization engine (e.g., prioritization engine 216). Remediation engine (e.g., remediation engine 218) may trigger compliance alerts, which an interaction engine (e.g., interaction engine 222) may display in a GUI along with a timeline showing a point in time at which the vulnerable images were deployed and which services are affected. Remediation engine may also generate a set of commands (e.g., Kubernetes commands in a Kubernetes environment) to update the affected deployments to a patched version (e.g., generated code snippets). An administrator (or other DevOp team member) may interact with interaction engine to query: “What services will be impacted by this update?”. The administrator (or other DevOp team member) may review the root-cause analysis and approve the update. Remediation engine 218 may orchestrate a rolling update of the affected services, ensuring minimal downtime. The successful patching process can be shared (in an anonymized, privacy-preserving manner) with other clusters to help other clusters train a root-cause analyzer system of their own on the issue.

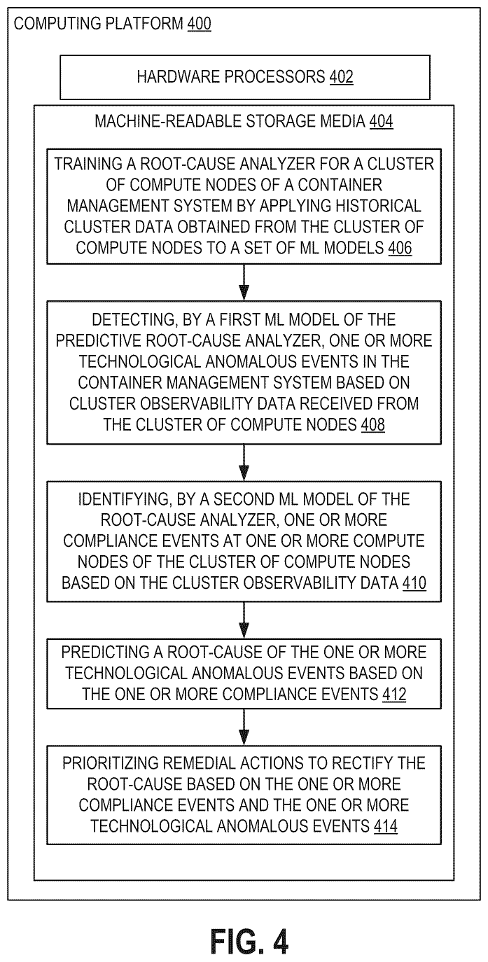

FIG. 4 illustrates a computing component that may be used to implement a predicative root-cause analyzer in accordance with various examples of the disclosed technology. Referring now to FIG. 4, computing component 400 may be, for example, a server computer, a controller, or any other similar computing component capable of processing data. In the example implementation of FIG. 4, the computing component 400 includes a hardware processor 402, and machine-readable storage medium for 404. The computing component 400 be an example implementation or included as part of root-cause analyzer system 130 and/or root-cause analyzer system 200.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-414, to control processes or operations disclosed herein. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-414.

Hardware processor 402 may execute instruction 406 to train a root-cause analyzer for a cluster of compute nodes of a container management system by applying historical cluster observability data obtained from the cluster of compute nodes to a set of ML models. In examples, instructions 406 may be executed by ML training engine 212 of FIG. 2 to train the set of ML models as described above. In an illustrative example, the compute nodes may be worker nodes of a Kubernetes environment. In examples, the historical cluster observability data may comprise metric data, trace data, and log entry data, for example, collected and processed by data processing module 210 of FIG. 2.

Hardware processor 402 may execute instruction 408 to detect, by a first ML model of the root-cause analyzer, one or more technological anomalous events in the container management system based on cluster observability data received from the cluster of compute nodes. In examples, instructions 408 may be executed by root-cause detection engine 214 of FIG. 2 as described above. In examples, the cluster observability data may include metric data, trace data, and log entry data, for example, collected and processed by data processing module 210 of FIG. 2.

Hardware processor 402 may execute instruction 410 to identify, by a second ML model of the root-cause analyzer, one or more compliance events at one or more compute nodes of the cluster of compute nodes based on the cluster observability data. In examples, instructions 410 may be executed by root-cause detection engine 214 of FIG. 2 as described above. In examples, the one or more compliance events comprise one or more of a security compliance violation and a governance compliance violation.

Hardware processor 402 may execute instruction 412 to predict a root-cause of the one or more technological anomalous events based on the one or more compliance events. In some examples, predicting the root-cause may include identifying an anomalous pattern from the one or more technological anomalous events, correlating the one or more compliance events with the anomalous pattern, and identifying the root-cause of the one or more technological anomalous events based on the correlation. In examples, instructions 412 may be executed by root-cause detection engine 214 of FIG. 2 as described above.

Hardware processor 402 may execute instruction 414 to prioritize remedial actions to rectify the root-cause based on the one or more compliance events and the one or more technological anomalous events. In some examples, prioritizing remedial actions may include determining a risk score for the root-cause based on the one or more technological anomalous events and the one or more compliance events, and ranking the root-cause with respect to another root-cause based on the risk score. In some examples, determining the risk score can include applying the one or more technological anomalous events and the one or more compliance events to a third ML model of the root-cause analyzer. The third ML model can be trained to predict risk scores of root-causes. In examples, instructions 414 may be executed by prioritization engine 216 of FIG. 2 as described above.

In some examples, hardware processor 402 may execute instructions to train the root-cause analyzer on remedial actions using reinforcement learning. Based on this training, hardware processor 402 may generate the remedial actions. For example, hardware processor 402 may be configured to execute remediation engine 218 of FIG. 2 to train and generate remedial actions as described above.

In some examples, hardware processor 402 may execute instructions to provide a UI for interacting with the root-cause analyzer. For example, hardware processor 402 may be configured to generate a visualization of a structural topography of the cluster of the compute nodes, and display the predicting a root-cause on the structural topography. In some examples, hardware processor 402 may provide a time slider that can be utilized for exploring temporal causality of the one or more technological anomalous, the one or more compliance events, and the predicted root-cause. For example, hardware processor 402 may be configured to execute interaction engine 222 of FIG. 2 as described above.

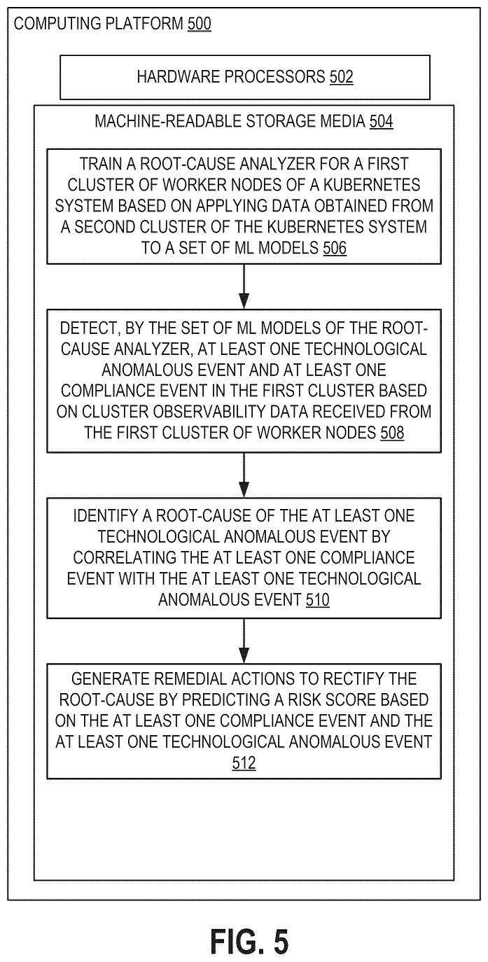

FIG. 5 illustrates a computing component that may be used for root-cause analysis of a Kubernetes environment in accordance with various examples of the disclosed technology. Referring now to FIG. 5, computing component 500 may be, for example, a server computer, a controller, or any other similar computing component capable of processing data. In the example implementation of FIG. 5, the computing component 500 includes a hardware processor 502, and machine-readable storage medium for 504. The computing component 400 be an example implementation or included as part of root-cause analyzer system 130 and/or root-cause analyzer system 200.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-512, to control processes or operations disclosed herein. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-512.

Hardware processor 502 may execute instruction 506 to train a root-cause analyzer for a first cluster of worker nodes of a Kubernetes system based on applying data obtained from a second cluster of the Kubernetes system to a set of machine learning ML models. In examples, the data obtained from second cluster of the Kubernetes system comprises one of a one or more ML models for the second cluster and cluster observability data obtained from worker nodes of the second cluster. In an illustrative example, the first cluster may be cluster 310A of FIG. 3 and the second cluster may be cluster 310N. In this case, instructions 506 may train, for example, root-cause analyzer system 330 of cluster 310A using data obtained from cluster 310N. The root-cause analyzer, in some examples, may be implemented as root-cause analyzer system 330 and/or root-cause analyzer system 200. In an example, instruction 506 may be executed by ML training engine 212 and the data may be processed by data processing module 210.

Hardware processor 502 may execute instruction 508 to detect, by the set of ML models of the root-cause analyzer, at least one technological anomalous event and at least one compliance event in the first cluster based on cluster observability data received from the first cluster of worker nodes. In examples, the at least one compliance event comprises one or more of a security compliance violation and a governance compliance violation, for example, based on checking compliance criteria (e.g., security compliance criteria 148 and/or security compliance criteria 348). As described above in connection with FIG. 2, instruction 508 may be executed by root-cause detection engine 214 to detect both technological anomalous events and compliance events.

Hardware processor 502 may execute instruction 510 to identify a root-cause of the at least one technological anomalous event by correlating the at least one compliance event with the at least one technological anomalous event. In an example, instruction 510 may be executed by root-cause detection engine 214 to integrate the compliance event into root-cause analysis pipeline by correlating the two for root-cause detection, prediction, and resolution.

Hardware processor 502 may execute instruction 512 to generate remedial actions to rectify the root-cause by predicting a risk score based on the at least one compliance event and the at least one technological anomalous event. In examples, instruction 512 may execute remediation engine 218 to generate remedial actions for the identify root-cause, which may be ranked against remedial actions for other root-causes according to risk scores predicted by prioritization engine 216. In examples, remediation engine 218 may perform reinforcement learning to learn remedial actions, as described above in connection with FIGS. 1 and 2, which can be recommended and/or executed automatically depending on the desired application.

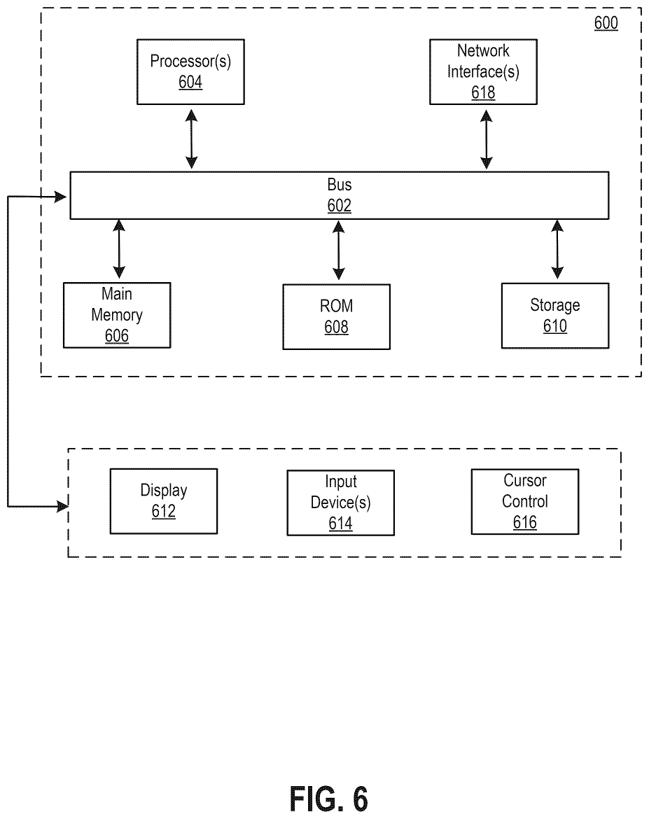

FIG. 6 depicts a block diagram of an example computer system 600 in which various examples of the disclosed technology described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors. The computer system 6000 may be implemented as one or more component of the components of FIGS. 1-3, for example, worker nodes 104, master node 102, front-end system 150, root-cause analyzer system 200, third party system(s) 208, worker nodes 304, master nodes 302, and worker nodes 314.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. For example, main memory 606 may store instructions, that when executed by processor(s) 604, cause computer system 600 to perform one or more of the operations described in connection with FIGS. 4 and 5.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some examples, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a network interface 618 (also referred to as a communication interface) coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 618, which carry the digital data to and from computer system 600, are example forms of transmission media.

The computer system 600 can send messages and receive data, including program code, through the network(s), network link and network interface 618. In the Internet example, a server might transmit a requested code for an application program through the Internet, the ISP, the local network and the network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
training a root-cause analyzer for a cluster of compute nodes of a container management system by applying historical cluster observability data obtained from the cluster of compute nodes to a set of machine learning (ML) models;
detecting, by a first ML model of the root-cause analyzer, one or more technological anomalous events in the container management system based on cluster observability data received from the cluster of compute nodes;
identifying, by a second ML model of the root-cause analyzer, one or more compliance events at one or more compute nodes of the cluster of compute nodes based on the cluster observability data;
predicting a root-cause of the one or more technological anomalous events based on the one or more compliance events; and
prioritizing remedial actions to rectify the root-cause based on the one or more compliance events and the one or more technological anomalous events.

2. The method of claim 1, wherein the historical cluster observability data comprises metric data, trace data, and log entry data.

3. The method of claim 1, wherein the one or more compliance events comprise one or more of a security compliance violation and a governance compliance violation.

4. The method of claim 1, wherein the predicting the root-cause comprises:
identifying an anomalous pattern from the one or more technological anomalous events;
correlating the one or more compliance events with the anomalous pattern; and
identifying the root-cause of the one or more technological anomalous events based on the correlation.

5. The method of claim 1, wherein prioritizing remedial actions comprises:
determining a risk score for the root-cause based on the one or more technological anomalous events and the one or more compliance events; and
ranking the root-cause with respect to another root-cause based on the risk score.

6. The method of claim 1, wherein determining the risk score comprises:
applying the one or more technological anomalous events and the one or more compliance events to a third ML model of the root-cause analyzer, wherein the third ML model is trained to predict risk scores of root-causes.

7. The method of claim 1, further comprising:
training the root-cause analyzer on remedial actions using reinforcement learning; and
generating the remedial actions based on the training.

8. The method of claim 1, further comprising:
generating a visualization of a structural topography of the cluster of the compute nodes; and
displaying the predicting a root-cause on the structural topography.

9. The method of claim 1, wherein the container management system is a Kubernetes and the cluster is a Kubernetes environment.

10. A system, comprising:
a memory storing instructions; and
a processor communicably coupled to the memory and configured to execute the instructions to:
train a root-cause analyzer for a cluster of compute nodes of a container management system by applying historical cluster observability data obtained from the cluster of compute nodes to a set of machine learning (ML) models;
detect, by a first ML model of the root-cause analyzer, one or more technological anomalous events in the container management system based on cluster observability data received from the cluster of compute nodes;
identify, by a second ML model of the root-cause analyzer, one or more compliance events at one or more compute nodes of the cluster of compute nodes based on the cluster observability data;
predict a root-cause of the one or more technological anomalous events based on the one or more compliance events; and
prioritize remedial actions to rectify the root-cause based on the one or more compliance events and the one or more technological anomalous events.

11. The system of claim 7, wherein the container management system is a Kubernetes and the cluster is a Kubernetes environment.

12. The system of claim 7, wherein the processor is further configured to execute the instructions to:
identify an anomalous pattern from the one or more technological anomalous events;
correlate the one or more compliance events with the anomalous pattern; and
identify the root-cause of the one or more technological anomalous events based on the correlation.

13. The system of claim 7, wherein the processor is further configured to execute the instructions to:
determine a risk score for the root-cause based on the one or more technological anomalous events and the one or more compliance events; and
rank the root-cause with respect to another root-cause based on the risk score.

14. The system of claim 7, wherein the processor is further configured to execute the instructions to:
apply the one or more technological anomalous events and the one or more compliance events to a third ML model of the root-cause analyzer, wherein the third ML model is trained to predict risk scores of root-causes.

15. The system of claim 7, wherein the processor is further configured to execute the instructions to:
train the root-cause analyzer on remedial actions using reinforcement learning; and
generate the remedial actions based on the training.

16. The system of claim 7, wherein the processor is further configured to execute the instructions to:
generate a visualization of a structural topography of the cluster of the compute nodes; and
display the predicting a root-cause on the structural topography.

17. A non-transitory computer-readable storage medium storing instructions that, when executed by a processor, cause the processor to:
train a root-cause analyzer for a first cluster of worker nodes of a Kubernetes system based on applying data obtained from a second cluster of the Kubernetes system to a set of machine learning (ML) models;
detect, by the set of ML models of the root-cause analyzer, at least one technological anomalous event and at least one compliance event in the first cluster based on cluster observability data received from the first cluster of worker nodes;
identify a root-cause of the at least one technological anomalous event by correlating the at least one compliance event with the at least one technological anomalous event; and
generate remedial actions to rectify the root-cause by predicting a risk score based on the at least one compliance event and the at least one technological anomalous event.

18. The non-transitory computer-readable storage medium of claim 17, wherein the data obtained from second cluster of the Kubernetes system comprises one of a one or more ML models for the second cluster and cluster observability data obtained from worker nodes of the second cluster.

19. The non-transitory computer-readable storage medium of claim 17, wherein the at least one compliance event comprises one or more of a security compliance violation and a governance compliance violation.

20. The non-transitory computer-readable storage medium of claim 17, wherein identifying the root-cause comprises:
responsive to detecting an update to one of security compliance requirements and governance compliance requirements, retraining the set of ML models on the updated to one of security compliance requirements and governance compliance requirements.
